(19) United States
(12) Patent Application Publication
(10) Pub. No.: US 2007/0226377 A1
(43) Pub. Date: Sep. 27, 2007

(54) Detecting parameters of a system UART and matching those parameters in a serial-over-LAN (SOL) UART

(75) Inventors: Elie Jreij, Pflugerville, TX (US); Wai-ming R. Chan, Austin, TX (US); Anand Joshi, Round Rock, TX (US); Pedro Lopez, Austin, TX (US)

Correspondence Address: BAKER BOTTS, LLP, 910 LOUISIANA, HOUSTON, TX, 77002-4995, US

(73) Assignee: Dell Products L.P.

(21) Appl. No.: 11/350,458

(22) Filed: Feb. 9, 2006

(51) Int. Cl. G06F 3/00

(52) U.S. Cl. 710/8

(57) ABSTRACT

An information handling system has the capability of matching UART baud rates and other serial data parameters between a system UART and baseboard management controller (BMC) UART used for serial-over-LAN (SOL) access to the information handling system via an Ethernet connection, either locally or remotely by a user, administrator, maintenance technician, etc. The BMC may snoop set-up data sent to the control register(s) of the system UART, look up a corresponding baud rate from a baud rate table of the BMC and set the BMC UART to match the system UART baud rate and other serial data parameters so that SOL access to the information handling system is available no matter what baud rate and/or serial data parameters an application may have programmed the system UART configuration registers. The BMC may snoop system UART data over a simple data bus such a low pin count (LPC) bus.

### TECHNICAL FIELD

The present disclosure relates generally to information handling systems and, more particularly, to detecting parameters of an information handling system UART and matching those parameters in a serial-over-LAN (SOL) UART.

### BACKGROUND

As the value and use of information continues to increase, individuals and businesses seek additional ways to process and store information. An option available to users is an information handling system. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems, e.g., computer, personal computer workstation, portable computer, computer server, print server, network router, network hub, network switch, storage area network disk array, RAID disk system and telecommunications switch.

Information handling systems are becoming more and more important in both business and personal life. Important and critical information handling systems may be remote and/or unattended such as for example, but not limited to, servers and/or storage devices. Users and/or administrators may access an information handling system over local serial Ethernet communications channels, e.g., local area networks (LANs) and/or over long distances, e.g., wide area networks (WANs) and the Internet by using serial-over-LAN (SOL).

### SUMMARY

The Intelligent Platform Management Interface (IPMI) specification (version 2.0), hereby incorporated by reference herein for all purposes, defines a serial-over-LAN (SOL). A baseboard management controller (BMC) of an information handling system may pass serial data back and forth between the information handling system serial port and a remote LAN console. Using SOL allows remote control of BIOS setup, DOS applications, Windows SAC (Special Administrator Console), Linux Getty and many other control and maintenance applications from a remote site. In addition, a local application may utilize resources at a remote site over SOL. A problem exists, however, in that if there is a different baud rate at a remote site from what is programmed in the BMC serial UART of the information handling system, the information handling system and remote site will not be able to communicate over SOL because any data sent and/or received from/to an application will be garbled.

According to a specific example embodiment of this disclosure, an information handing system may comprise a method for matching parameters of a serial-over-LAN (SOL) UART to operational parameters of an information handling system UART, said method comprising the steps of: determining when new configuration data is written to configuration registers of a system UART; reading the new configuration data; and determining from the configuration data what parameters to use for configuring a serial-over-LAN (SOL) UART, wherein the SOL UART and the system UART have compatible operational parameters.

According to another specific example embodiment of this disclosure, an information handing system may comprise a method for matching a baud rate of a serial-over-LAN (SOL) UART to a baud rate of an information handling system UART, said method comprising the steps of: programming a keyboard controller style (KCS) channel with the system UART address; generating a KCS channel read data interrupt to read a bit of a line control register of the system UART; determining whether the bit is set of the line control register of the system UART, wherein if the bit is not set then return to the step of programming the KCS channel with the system UART address, and if the bit is set then monitor a divisor value in a least significant byte (LSB) register of the system UART; generating another KCS channel read data interrupt to read new data from the LSB register of the system UART; determining a baud rate of the system UART by comparing the data from the LSB register with a look-up table of corresponding baud rates; and programming the SOL UART to the baud rate determined in the look-up table.

According to yet another specific example embodiment of this disclosure, an information handing system having system UART baud rate detection and matching of the system UART baud rate in a serial-over-LAN (SOL) UART, may comprise a super input-output (I/O) having a system UART; a baseboard management controller (BMC) having a serial-over-LAN (SOL) UART and a keyboard controller style (KCS) interface coupled to a KCS channel of a low pin count (LPC) bus, wherein the LPC bus is also coupled to the super I/O; wherein the BMC reads configuration data written to the system UART configuration registers for determining a baud rate of the system UART, and the BMC sets the SOL UART to the baud rate of the system UART.

### BRIEF DESCRIPTION OF THE DRAWINGS

A more complete understanding of the present disclosure thereof may be acquired by referring to the following description taken in conjunction with the accompanying drawings wherein:

FIG. 1 is a schematic block diagram of an information handling system;

FIG. 2 is a schematic block diagram of a prior technology UART port connection between a BMC UART and system UART;

FIG. 3 is a schematic block diagram of a BMC to LPC interface, according to a specific example embodiment of the present disclosure; and

FIG. 4 is a flow diagram for determining the baud rate of a system UART, according to a specific example embodiment of the present disclosure.

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU), hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Referring now to the drawings, the details of specific example embodiments are schematically illustrated. Like elements in the drawings will be represented by like numbers, and similar elements will be represented by like numbers with a different lower case letter suffix.

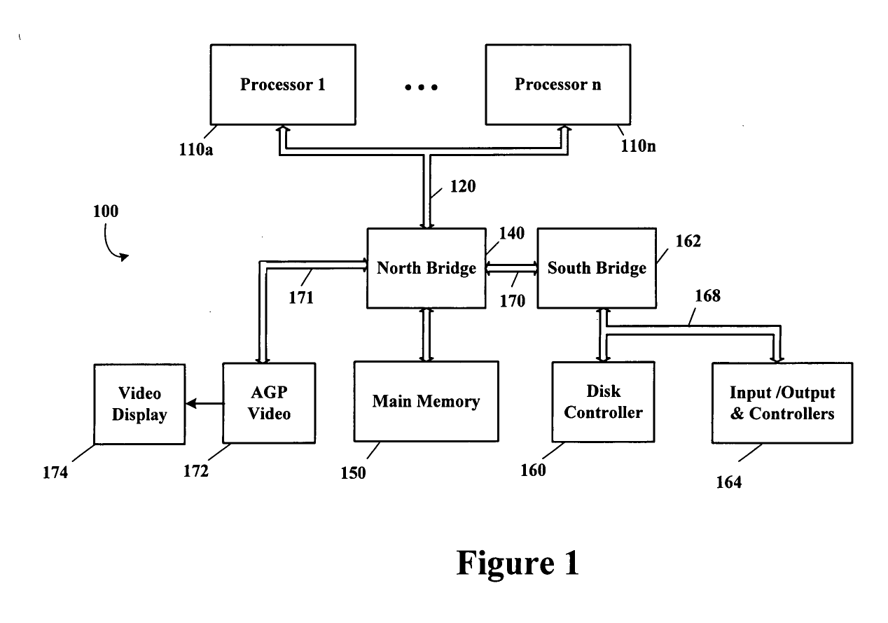

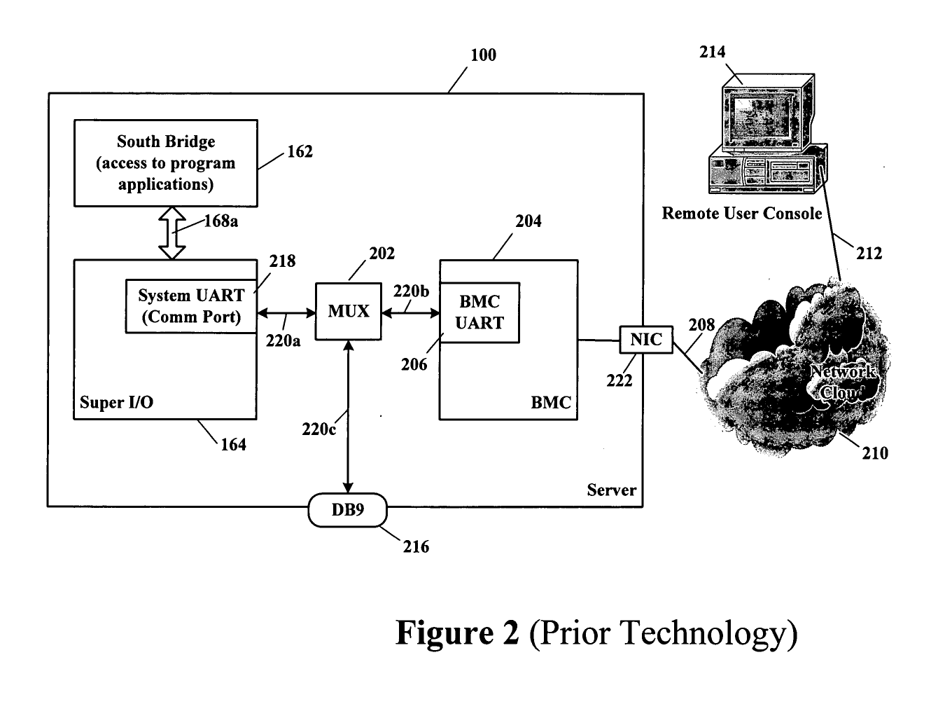

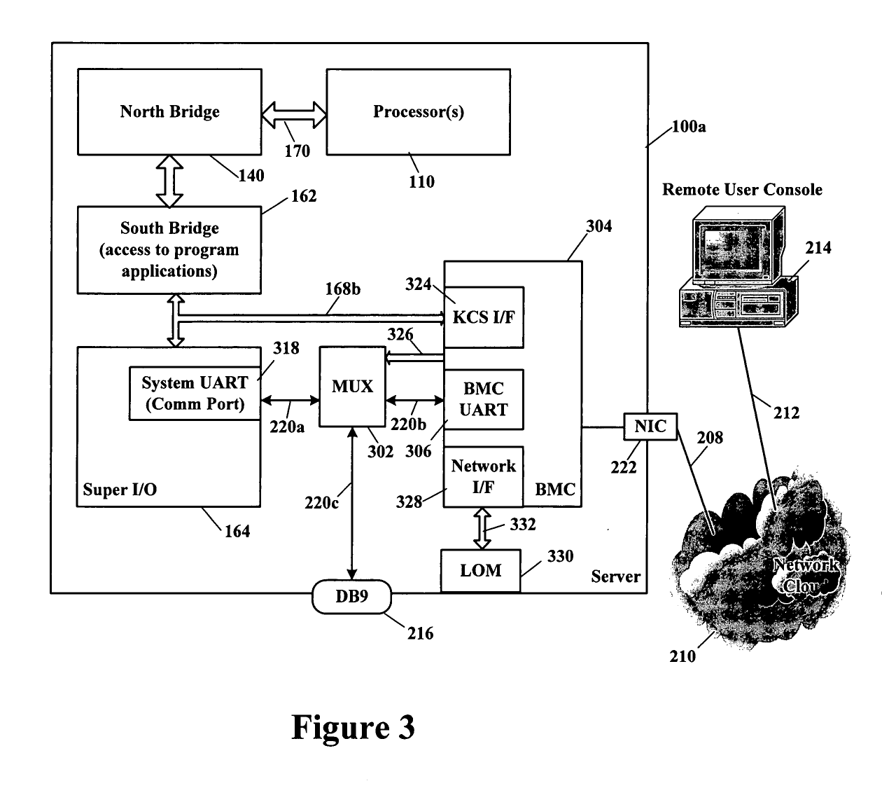

Referring to FIG. 1, depicted is an information handling system having electronic components mounted on at least one printed circuit board (PCB) (motherboard) and communicating data and control signals over signal buses. In one example embodiment, the information handling system is a computer system. The information handling system, generally referenced by the numeral 100, comprises a plurality of physical processors 110, generally represented by processors 110a-110n, coupled to a host bus(es) 120. A north bridge 140, which may also be referred to as a memory controller hub or a memory controller, is coupled to a main system memory 150. The north bridge 140 is coupled to the plurality of processors 110 via the host bus(es) 120. The north bridge 140 is generally considered an application specific chip set that provides connectivity to various buses, and integrates other system functions such as a memory interface. For example, an Intel 820E and/or 815E chip set, available from the Intel Corporation of Santa Clara, Calif., provides at least a portion of the north bridge 140. The chip set may also be packaged as an application specific integrated circuit (ASIC). The north bridge 140 typically includes functionality to couple the main system memory 150 to other devices within the information handling system 100. Thus, memory controller functions such as main memory control functions typically reside in the north bridge 140. In addition, the north bridge 140 provides bus control to handle transfers between the host bus 120 and a second bus(es), e.g., PCI bus 170, AGP bus 171 coupled to a video graphics interface 172 which drives a video display 174. A third bus(es) 168 may also comprise other industry standard buses or proprietary buses, e.g., ISA, SCSI, I²C, SPI, USB, low pin count (LPC) buses through a south bridge(s) (bus interface) 162. A disk controller 160 and input/output interface(s) 164 may be coupled to the third bus(es) 168. At least one of the input/output interfaces 164 may be used in combination with a baseboard management controller, serial port and/or Ethernet network interface card (NIC) (see FIGS. 2 and 3).

Referring now to FIG. 2, depicted is a schematic block diagram of a prior technology UART port connection between a BMC UART and system UART. Typically, the south bridge 162 may be coupled to super input/output (I/O) 164 through bus 168a. The super I/O may comprise a system UART (serial communications port) 218 coupled to a serial multiplexer 202 through a serial bus 220a. A baseboard management controller (BMC) 204 may comprise a BMC UART 206 coupled to the serial multiplexer 202 through a serial bus 220b. The serial multiplexer 202 may be coupled to an external local serial port 216, e.g., DB9 or DB25 connector of the information handling system 100 through a serial bus 220c. The serial multiplexer 202 is adapted to couple the system UART 218 to either the external local serial port 216 or the BMC UART 206. The BMC 204 may also be coupled to a network interface controller (NIC) 222. The NIC 222 is adapted for coupling to a network 210, e.g., local area network (LAN), wide area network (WAN), Internet, intranet, extranet, etc., through an Ethernet connection 208.

The BMC 204 may pass SOL serial data back and forth between the system UART 218 when the MUX 202 couples the UARTs 206 and 218 together, and a remote user console 214 via Ethernet connection 212, network 210, Ethernet connection 208 and NIC 222. However, if the BMC UART 206 and system UART 218 are programmed to different baud rates then SOL will not work and the remote client will only see garbled data.

Referring to FIG. 3, depicted is a schematic block diagram of a BMC to low pin count (LPC) interface, according to a specific example embodiment of the present disclosure. A low pin count (LPC) bus 168b couples a keyboard controller style (KCS) interface (KCS I/F) 324 to the super I/O 164 and south bridge 162. Normally, the BMC 304 may use the LPC bus 168b to implement KCS channels that may be used by BIOS and IPMI software drivers to communicate with the BMC 304. However, these KCS channels may also be used to decode and/or capture data from any I/O address on the LPC bus 168b, and thus may be used to monitor configuration data sent to the system UART 318. The BMC 304 may control operation of the MUX 302 over a local memory bus 326 for connecting the system UART 318 to the BMC UART 306 or the external local serial port 216.

The BMC 304 may program one of its LPC/KCS channels to decode the address of the system UART 318 configuration registers. When an application sets a new baud rate for the system UART 318, the application will write to these configuration registers and the BMC 304 may get an interrupt to indicate the occurrence of the write to the UART 318 configuration registers. The BMC 304 may snoop the date written to the UART 318 configuration registers for determining the new baud rate of the UART 318. The BMC 304 will then set the BMC UART 306 to match the new baud rate of the system UART 318. Therefore, a remote user console 214 using SOL will not encounter a baud rate mismatch problem when trying to access the information handling system 100a or visa-versa. A LAN-on-motherboard (LOM) 330 coupled to a network interface 328 of the BMC 304 and may be used instead of the NIC 222, e.g., the LOM 330 may be coupled to the network 210 via the Ethernet connection 208.

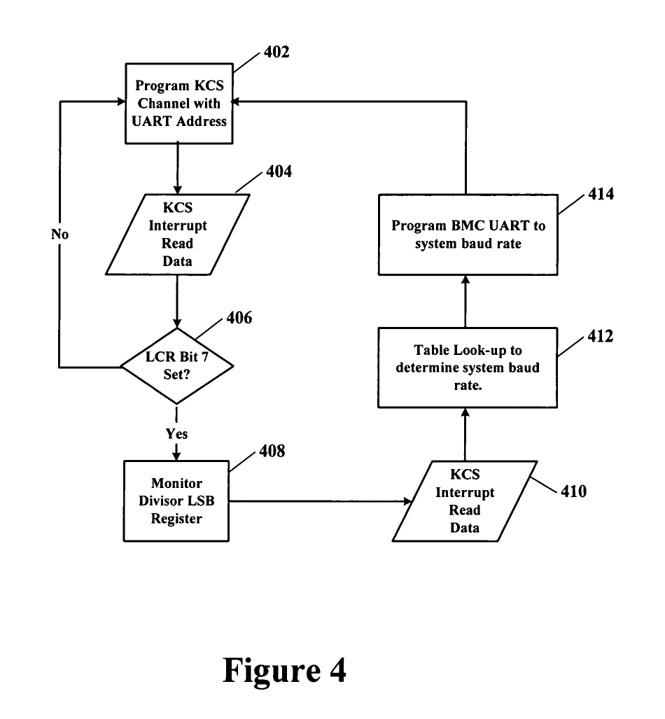

Referring to FIG. 4, depicted is a flow diagram for determining the baud rate of a system UART 318, according to a specific example embodiment of the present disclosure. In step 402, a KCS channel of the BMC 304 may be programmed with the address for the system UART 318. In step 404 a KCS interrupt is initiated so that the BMC 304 may read the address of the system UART 318. Step 406 determines whether bit 7 of the Line Control Register (LCR) is set (e.g., logic “1”). If bit 7 is not set, then a returned to step 402 is performed. If bit 7 is set, then a divisor in the least significant byte (LSB) register of the system UART 318 is monitored. Then in step 410 the KCS interrupt is again initiated so that the BMC 304 may read data from the LSB register. Then in step 412 there is a table look-up to determine the system UART 318 baud rate from the data read from the LSB register. Then in step 414 the BMC UART 306 is programmed to the same baud rate as the system UART 318 baud rate. A return back to step 402 prepares for determination of the next baud rate change to the system UART 318. In a similar fashion, other serial data transmission parameters, e.g., number of start and/or stop bits; even, odd or no parity, etc., may be snooped by the BMC 304 during set-up of the system UART 318 by an OS and/or application program.

As a specific example to illustrate the aforementioned operation in determining the baud rate of the system UART 318 and setting the BMC UART 306 to the same baud rate, assume that an operating system (OS), e.g., Linux, Windows, etc., redirects a text console to serial port COM 1 and sets this serial port to 57,600 baud. When the OS loads it may program the system UART 318 in the following manner:

Set the Line Control Register (LCR) bit 7 at address 0x3FB to logic “1.”

Write the baud rate divisor to registers 0x3F8 (LSB) and 0x3F9 (MSB).

Reset the LCR bit 7 at address 0x3FB to logic “0.”

The BMC 304 may have a table of baud rate divisors and corresponding baud rates. When the BMC 304 snoops what the OS and/or program application wrote to the baud rate register of the system UART 318, the BMC 304 uses the table of baud rate divisors to look-up a corresponding baud rate that matches the baud rate divisor found in the table to find the new baud rate of the system UART 318. For example, the baud rate divisor table may have the following entries:

| Divisor | Baud Rate |
|---|---|
| 1 | 115,200 |
| 2 | 57,600 |
| 3 | 38,400 |
| . . . | . . . |
| 0xC0 | 600 |
| 0x180 | 300 |

The BMC 304 need only monitor the LSB (least significant byte) of the baud rate registers because the MSB may be 0 for baud rates of 600 and above. Even for baud rates lower than 600 baud where the MSB is non-zero, the LSB is still unique and there is sufficient information therein to determine the correct baud rate from the baud rate divisor table. Thus according to the present disclosure, baud rate mismatch problems for IPMI SOL may be eliminated. In addition, no action by an information handling system user is required to set-up BMC UART 306 baud rates to match the system UART 318 baud rate for any operating system and/or applications program. Thus, different applications may use different baud rates without a user having to worry about system UART 318 and BMC UART 306 baud rate mismatches. Since the BMC 304 snoops the configuration data used to program the UART baud rate registers of the system UART 318, no data pattern recognition is required to match baud rates of the system UART 318 and the BMC UART 306.

While embodiments of this disclosure have been depicted, described, and are defined by reference to example embodiments of the disclosure, such references do not imply a limitation on the disclosure, and no such limitation is to be inferred. The subject matter disclosed is capable of considerable modification, alteration, and equivalents in form and function, as will occur to those ordinarily skilled in the pertinent art and having the benefit of this disclosure. The depicted and described embodiments of this disclosure are examples only, and are not exhaustive of the scope of the disclosure.

What is claimed is:

1. A method for matching parameters of a serial-over-LAN (SOL) UART to operational parameters of an information handling system UART, said method comprising the steps of:
determining when new configuration data is written to configuration registers of a system UART;
reading the new configuration data; and
determining from the configuration data what parameters to use for configuring a serial-over-LAN (SOL) UART, wherein the SOL UART and the system UART have compatible operational parameters.

2. The method according to claim 1, wherein the step of determining when new configuration data is written to the configuration registers of the system UART comprises the steps of:
programming a keyboard controller style (KCS) channel with the system UART address;
generating an interrupt so that the new configuration data is read; and
determining whether a bit is set in a line control register of the system UART.

3. The method according to claim 2, wherein if the bit is set in the system UART line control register then monitor a baud rate divisor in a least significant byte (LSB) register of the system UART.

4. The method according to claim 2, wherein if the bit is not set in the system UART line control register then return to the step of determining when new configuration data is written to the configuration registers of the system UART.

5. The method according to claim 3, wherein the step of determining from the configuration data what parameters to use for configuring the serial-over-LAN (SOL) UART, comprises the steps of:
determining the system UART parameters by comparing the new configuration data with SOL UART parameters stored in a look-up table, wherein the look-up table parameters are used to set parameters for the SOL UART; and
and programming the SOL UART with the SOL UART parameters determined from the look-up table, wherein the SOL UART and the system UART have compatible parameters.

6. The method according to claim 1, wherein a parameter is baud rate.

7. The method according to claim 1, wherein another parameter is parity.

8. The method according to claim 1, wherein the parameters are selected from the group consisting of one or more of the following: baud rate, odd parity, even parity, no parity, number of start bits and number of stop bits.

9. A method for matching a baud rate of a serial-over-LAN (SOL) UART to a baud rate of an information handling system UART, said method comprising the steps of:
programming a keyboard controller style (KCS) channel with the system UART address;
generating a KCS channel read data interrupt to read a bit of a line control register of the system UART;
determining whether the bit is set of the line control register of the system UART, wherein
if the bit is not set then return to the step of programming the KCS channel with the system UART address, and
if the bit is set then monitor a divisor value in a least significant byte (LSB) register of the system UART;
generating another KCS channel read data interrupt to read new data from the LSB register of the system UART;
determining a baud rate of the system UART by comparing the data from the LSB register with a look-up table of corresponding baud rates; and
programming the SOL UART to the baud rate determined in the look-up table.

10. The method according to claim 9, wherein the bit is bit 7 of the line control register of the system UART.

11. An information handling system having system UART baud rate detection and matching of the system UART baud rate in a serial-over-LAN (SOL) UART, said system comprising:
a super input-output (I/O) having a system UART;
a baseboard management controller (BMC) having a serial-over-LAN (SOL) UART and a keyboard controller style (KCS) interface coupled to a KCS channel of a low pin count (LPC) bus, wherein the LPC bus is also coupled to the super I/O;
wherein the BMC reads configuration data written to the system UART configuration registers for determining a baud rate of the system UART, and the BMC sets the SOL UART to the baud rate of the system UART.

12. The information handling system according to claim 11, wherein the configuration data read by the BMC is compared in a look-up table for determining the system UART baud rate for programming the baud rate of the SOL UART.

13. The information handling system according to claim 11, further comprising a network interface controller (NIC) coupled to the BMC such that when the SOL UART and the system UART are coupled together, a serial data session over the NIC may communicate with the information handling system.

14. The information handling system according to claim 13, wherein the NIC is coupled to a network.

15. The information handling system according to claim 14, wherein the network is selected from the group consisting of a local area network (LAN), a wide area network (WAN), Internet, intranet, and extranet.

16. The information handling system according to claim 14, wherein the NIC is coupled to the network with an Ethernet connection.

17. The information handling system according to claim 14, further comprising a remote user console coupled to the network.

18. The information handling system according to claim 14, wherein the NIC is a LAN-on-motherboard (LOM) coupled to a network interface of the BMC.

19. The information handling system according to claim 13, wherein the system UART and the BMC UART are coupled together with a multiplexer.

20. The information handling system according to claim 19, wherein the BMC controls the multiplexer.

21. The information handling system according to claim 20, wherein the BMC controls the multiplexer over a local memory bus.
